(19) United States
(12) Patent Application Publication
(10) Pub. No.: US 2015/0039504 A1
(43) Pub. Date: Feb. 5, 2015

(54) CHECK VERIFICATION AND REMOTE DEPOSIT CAPTURE

(71) Applicant: Cachet Financial Solutions Inc., Minneapolis, MN (US)

(72) Inventor: Christopher F. EBBERT, Minneapolis, MN (US)

(21) Appl. No.: 14/447,850

(22) Filed: Jul. 31, 2014

Related U.S. Application Data
(60) Provisional application No. 61/860,502, filed on Jul. 31, 2013.

(51) Int. Cl. G06Q 20/04; G06Q 20/10

(52) U.S. Cl. CPC G06Q 20/042; G06Q 20/108
USPC 705/42

(57) ABSTRACT

A remote deposit capture system is provides a remote deposit capture system that provides for physical manipulation of the financial instrument for deposit verification purposes.

### RELATED APPLICATIONS

The present application claims priority to, and incorporates by reference, U.S. Provisional Patent Application No. 61/860,502, filed on Jul. 31, 2013.

### BACKGROUND

1. Field of the Invention

This invention relates to a remote deposit capture method and apparatus. In particular, the invention relates to a method and apparatus for remote deposit capture of a financial instrument that provides for modification of the financial instrument after deposit to prevent redeposit. Of course, a person of ordinary skill in the art will understand that the invention is not necessarily so limited.

2. Background of the Invention

Remote Deposit Capture (“RDC”) had been termed one of the most important developments the banking industry has seen in years. The Federal Reserve, as well as nearly all of the top banks in the US, and other important financial institutions have either endorsed or launched RDC services.

In general terms, RDC is a service that allows a user to scan checks or other financial instruments and transmit the scanned images to a bank for posting and clearing. The basic requirements for an RDC service currently include a user computing device, an internet or network connection, a check scanner/digital camera or mobile device with a camera, and a RDC service provider such as a bank or a third party provider working with the bank. Financial instruments, such as checks, are scanned to create a digital image. This digital image is then transmitted (usually over an encrypted internet connection) to a RDC processor and are then eventually cleared for deposit.

The advantages of RDC are many. For businesses, the advantages include accelerated clearings, improved availability of banking services, enhanced cash flow, reduced costs, and consolidation of banking relationships. Similarly, RDC is beneficial to financial institutions by providing them with reduced transportation costs, new revenue streams and customers, and reduced processing and clearing costs. Consumers/users also benefit because they do not have to physically travel to a financial institution, and can conduct business with any institution and not just those located nearby.

RDC does suffer from significant drawbacks. In particular, the financial instrument is not physically altered in any manner to indicate that it has been processed. Traditionally, banks will mark the check, or take the check into their possession, which prevents the person cashing the check from presenting it again for deposit or other processing.

Accordingly, a need exists for a RDC system that overcomes the difficulties of the prior art by providing a means alter the financial instrument to prevent multiple transactions.

### SUMMARY OF THE INVENTION

An object of the present invention is to provide a RDC system that substantially eliminates the problems of the prior art.

These and other objects of the present invention will become apparent to those skilled in the art upon reference to the following specification, drawings, and claims. To that end, the present invention comprises a remote deposit capture system that provides for physical manipulation of the financial instrument for deposit verification purposes.

### BRIEF DESCRIPTION OF DRAWINGS

FIG. 1 is a system flow chart of the present invention.

FIG. 2 is a data context chart of the present invention.

FIG. 3 is a business rules flow chart.

FIG. 4 is a geolocation flow chart.

FIG. 5 is a fee capping flow chart.

FIG. 6 is a flow chart showing deposit verification.

### DETAILED DESCRIPTION OF THE PREFERRED EMBODIMENTS

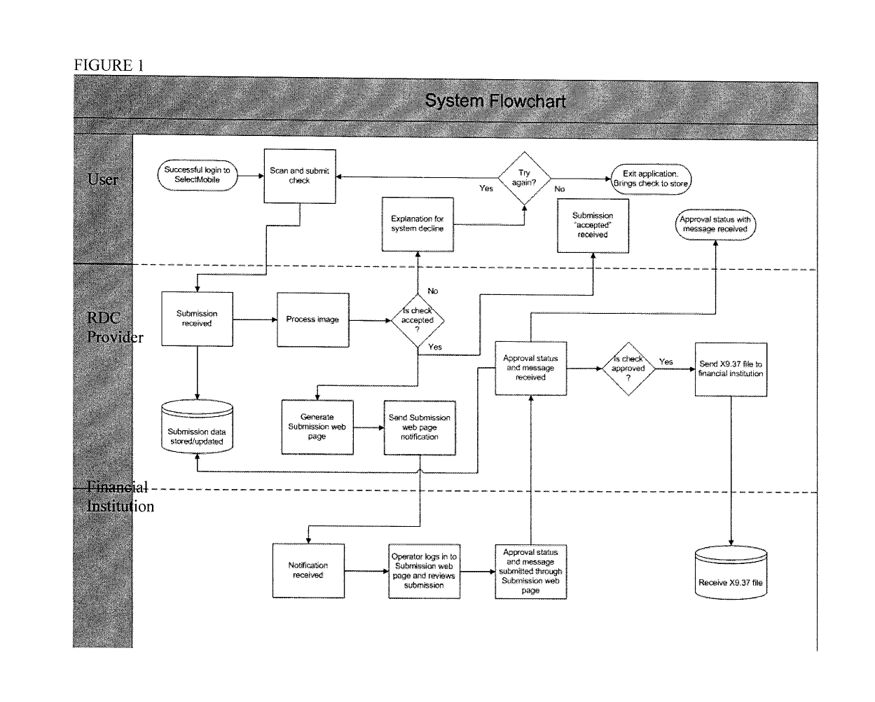

In the Figures, FIG. 1 shows a flowchart of the system of the present invention. The system operates between a user, a RDC provider, and a financial institution. The present invention is also applicable to financial services providers, such as check cashers and the like, and the RDC provider can be an independent entity providing outsourced services to the financial entity, or the financial entity itself can provide the RDC services. The process utilizes various hardware and software components, as described herein, which are distributed between the user, RDC provider, and the financial institution.

In the first step of the process, the user having been provided with or given access to a software application denoted SelectMobile (or other similar or related application), initiates a session by logging on to the application (a logon may not be necessary if the user is coming from a known source). The application can be distributed to a computing device at the user's site, or the user can remotely access the application from a computing device via a network connection, such as the Internet. The user's computing device can be of any conventional type that can either directly run the application, or provide network access to the application. Such devices can include a desktop computer, a server, a mobile computing device such as a smart phone, handheld computer, and the like.

After initiating a session, whereby the user has provided sufficient indicia of authenticity to access an account, the user will capture on the computing device an image of a financial instrument which the user desires the system to process. The capture can be accomplished with a scanning device, such as a flat bed scanner, a dedicated check scanner, or by utilizing a digital camera such as those commonly provided with handheld computing devices and/or smart phones or one interfaced with a desktop computer. The financial instrument in most cases would be a check that the user desires to deposit into a financial account with the financial institution or obtain cash/credit for, but could also be any other type of financial instrument processed by the financial institution such as a travelers check, a payment coupon, and the like.

After the financial instrument has been captured, an electronic or digital image of the instrument is then submitted electronically to the RDC provider for further processing. The RDC provider receives the submission and begins processing. The RDC provider utilizes a combination of software and hardware components generally operating in the provider's computer environment. The RDC provider's network, servers, and software are utilized for this purpose.

The submission data is stored in the RDC provider's database for data preservation and record keeping purposes.

The image of the financial instrument is then processed by the RDC provider. In the case of a check, the processing would include utilizing character recognition software to capture the MICR (magnetic ink character recognition) information from the digital image of the financial instrument such as the account number of the account the check is written against, name, address, bank routing information, and check number. MICR processing can take place on the level of the user's computing device, particularly if that device is a mobile device, or on the server level by the RDC provider or financial institution. Additional information captured from the financial instrument includes information provided by CAR/LAR processing software. CAR/LAR (Courtesy Amount Recognition/Legal Amount Recognition) provides an automated method to capture and compare the written value and the numeric value lines on the financial instrument.

Next, a determination is made as to whether the check meets the predefined acceptance criteria used by the system. This evaluation would include determining if the information captured during the processing step is accurate, internally consistent, and valid. If the financial instrument is not acceptable, then the user is notified and may be provided with an explanation as to the reason why the instrument was not accepted. The user is then given the choice to reprocess the instrument, or exit the application. The user always has the option of taking the financial instrument directly to a financial institution.

If the financial instrument is accepted, a submission received message is transmitted to the user so that the user is aware that at least initially the financial instrument has been successfully initially processed (but not fully accepted). As described below, additional processing and evaluation must occur before the financial instrument is finally accepted and deposited by the financial institution. The system cannot complete the transaction without the additional verification steps as described below.

After the submission received message is sent to the user, the system then generates a submission web page, which is then sent to the financial institutions computer processing system. This message can be sent via a computer network such as the Internet, through a local or intranet system, or it can be sent by a messaging system such as email or instant messaging.

At this point, processing is transferred to the financial institutions computer processing system. The notification sent from the RDC Processor is received by the financial institution. This notice would include all the information necessary for the financial institution to process and evaluate the financial instrument, including, the account number, routing number, check number, amount of the check, as well as the digital image of the front and back of the check/financial instrument. The notification may include information about multiple transactions for the user being processed at the same time, past history of user transactions, account status, or other information.

As stated above, the information can be passed to the financial institution in various manners. For example, the notification can be posted to a web page monitored by the financial institution, sent to an email account, and the like.

The information is then forwarded, or accessed, by an operator at the financial institution. The operator is preferably, but not necessarily, a human being qualified and trained to evaluate the financial instrument. The operator has access to all of the information in the notification, including, the digital image of the financial instrument. While the system itself includes evaluations and tests to authenticate, evaluate, and verify the financial instrument, this may not be the same as allowing a skilled professional human operator to review the instrument. While computer systems can be programmed to find and detect irregularities, human skill, judgment, knowledge, and reasoning is far superior at finding and detecting irregular, fraudulent, or suspect transactions.

Next, the operator will submit an evaluation of the financial instrument, either approving or rejecting the instrument. If the instrument is rejected an explanation could be included indicating the reason for rejection. This information is submitted to the RDC provider for processing and notice to the user.

If the transaction is approved by the operator, the RDC Processor then sends a formal file to the financial institution that conforms to applicable standards for the transfer exchange of images of financial instruments between financial institutions, banks, and/or the Federal Reserve. In the most preferred embodiment, the information is sent in the X9.37 format. This file is then received by the financial institution and processed through its general ledger.

If the transaction is approved, the RDC provider sends a message to the user indicating the approval status. If the financial institution operator does not approve the transaction then a transaction denied message can be sent to the user through the RDC provider.

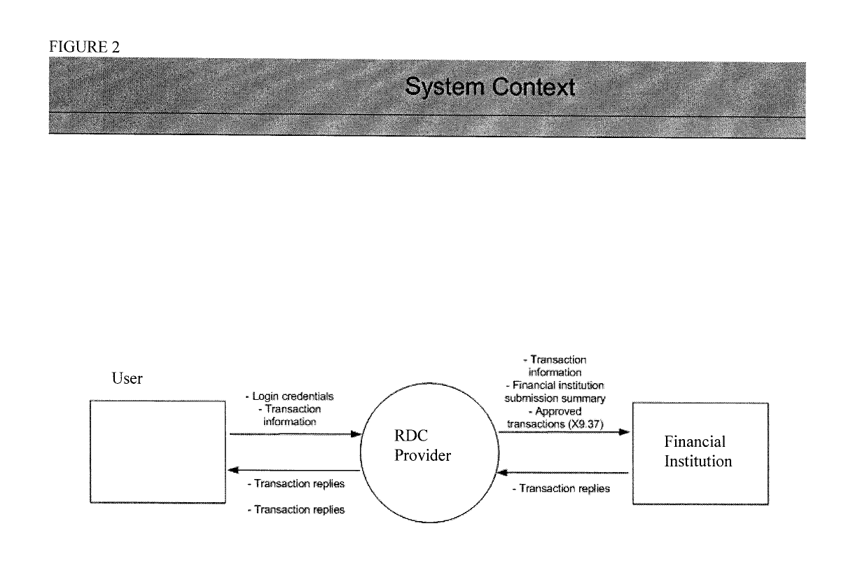

FIG. 2 is a system context chart showing generally the data exchange paths between the user, RDC provider, and the financial institution. The sequence of processing steps is described above in reference to FIG. 1.

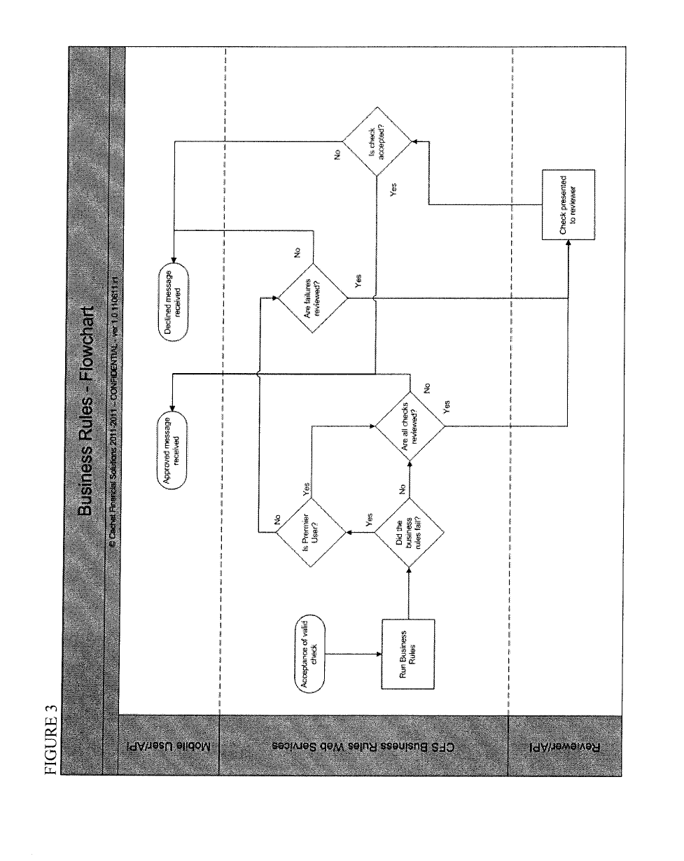

Alternative embodiments of the invention are set forth in FIGS. 3-5. In FIGS. 3-5, generally, the Mobile User/API would likely take place on the user level shown in FIG. 1, the CFS Business Rules Web Service would take place on the RDC provider or the financial institution levels shown in FIG. 1, and the Reviewer/API would take place on the financial institution level shown in FIG. 1.

FIG. 3 shows that the acceptance of a valid check is dependent on evaluation of a plurality of business rules. These rules include such things as: whether the check is written by a premier/white-list user (which is validated under any circumstances); whether the check is written by a black-list user (which is never validated or is only validated based on separate approval/review); amount difference (fails validation if the user entered amount and the system recognized amount are different); maximum dollar amount per deposit (fails validation if the total amount in the current deposit is greater than a pre-defined value); maximum number of checks per deposit (fails validation if the total quantity of checks in the current deposit is greater than a pre-defined number over a pre-defined period of time); maximum dollar amount per day (fails validation if the total amount (including the current deposit) is greater than a pre-defined value); maximum number of items per day (fails validation if the total number of items (including the current deposit) is greater than a pre-defined value); duplicate check (fails validation if the current check is a duplicate of a check already processed or being processed in the system); or geographical location (fails validation if the location of the deposit is outside of a specified geographical boundary—where geographical location is determined based on user input or geolocation data available from the user's computing device or network). Other similar rules can be included, and the rules and rule values can be determined by the financial institution, or based on default settings provided by the RDC provider.

Next, the results of the rules check are evaluated and if any rule fails, indicating that the check will not be validated, control passes to the determine premier/white-list user. If the user is a premier or white-list user then control passes to the “Are all checks reviewed?” box. If the user is not a premier or white-list user then control passes to the “Are failures reviewed?” box.

The “Are all checks reviewed?” box provides an option for all checks, even those validated under the business rules to receive additional, and preferably, human review. If the checks are to be reviewed, the checks are presented for review. If not, an approved message is sent to the user.

The “Are failures reviewed?” box provides and option to review checks that have failed one or more of the business rules. If the failures are reviewed, the checks are presented for review. If not, a declined message is sent to the user.

For checks presented for additional review, an additional evaluation is done to determine if they should still pass the review. If the check is passed, an approved message is sent to the user. If not, a declined message is sent.

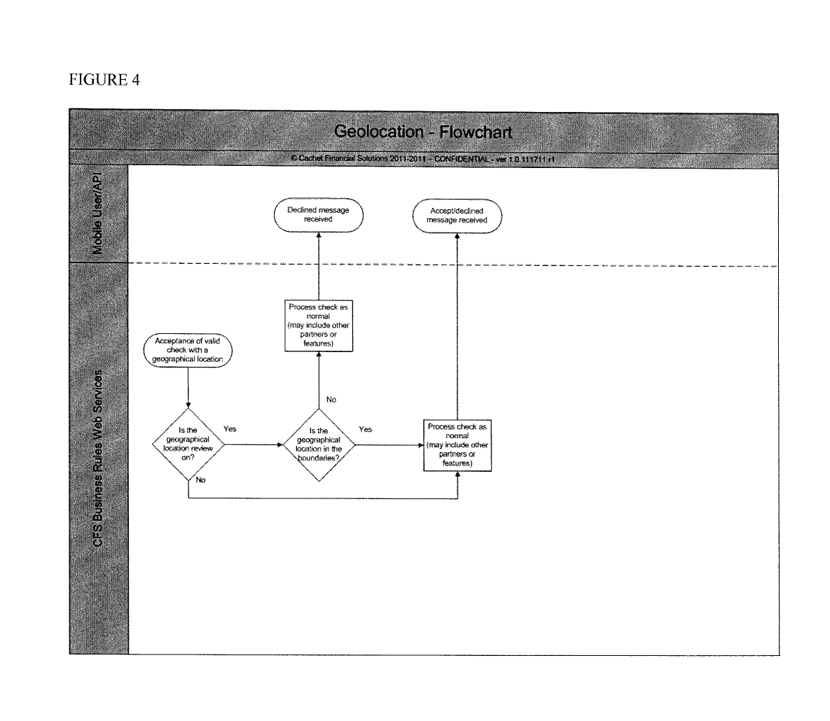

FIG. 4 presents the geographical rule in more particular detail. The purpose of the rule is to allow a financial institution to enforce a rule prohibiting validation of transactions that take place from certain geographic locations. For example, certain geographic locations may be associated with fraud—and transactions originating therein can therefore be prohibited, or the system could seek to verify whether a user is in a location that is unexpected given the user's stated address—in which case the transaction could be prohibited.

The process of acceptance or evaluation of a check based on geographic location begins by determining whether the geographic location rule is enabled. If the rule is not enabled processing control returns to the next step in the process bypassing the geographic rules step. If the rule is enabled, the process verifies whether the geographic location of the user is within the predefined boundaries set by the financial institution. Again, the institution has a variety of choices on how to determine boundaries. The rule could be set to not accept any check from a location outside the United States. They rule could be set to no accept any check from certain countries, or territories within a country.

If the location is outside the boundary, processing returns to the next step with a flag that the geolocation rule has failed, which presumably would lead to a process declined message being sent to the user (subject to other rules described above).

The location information preferably is based on a geolocation signal received from the user. For, example from the user's cell phone, or the geolocation information could come from the user's device ip address, or the like. Alternatively, the user can be asked to provide their location (although preferably the information would be come from an automated source that is presumably more reliable).

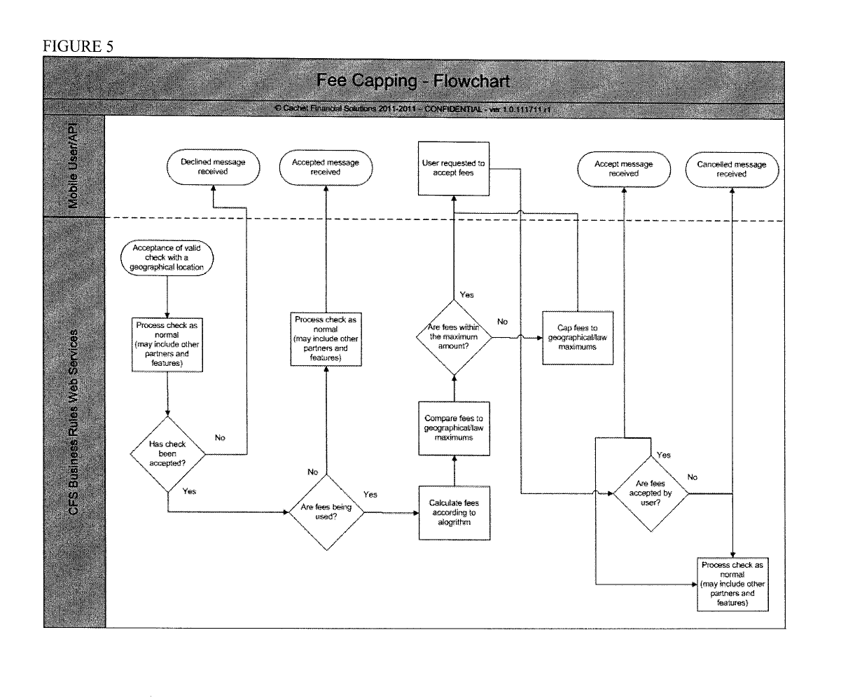

FIG. 5 discloses an additional embodiment of the invention that generally takes place after the rules phase described above. This phase of the invention involves procedures for setting fees charged by the financial institutions for processing the user's transaction.

The process essentially begins with a check to determine if the check has passed the prior rules. If not, the check is declined and no fees are assessed. If yes, then a determination is made as to whether the fee determination feature is enabled. If not, then processing returns to the normal flow.

If the fee step is enabled, the first step performed is to determine the fee according to the financial institutions algorithm. This will vary from institution to institution, but generally is based on a flat fee per transaction, or the fee can be based on some percentage of the transaction amount, or some combination of the foregoing. For example, if the check is under a certain amount then a fixed fee applies, over a certain amount a percentage applies, or vice versa. Next, the fee calculated according to the algorithm is compared against maximum amount as determined by the applicable legal standard in the jurisdiction where the user is located. Location information can be obtained in the manner described above in reference to the procedure describe in FIG. 4.

The calculated fee is compared to the maximum fee (if applicable), and the fee is set at either the lesser of the calculated fee or the maximum fee. The user is then prompted to accept the fee. If the fee is accepted then a transaction accepted message is transmitted. If the fees are not accepted, the transaction is cancelled.

In this manner the system of the present invention substantially overcomes the limitations of the prior art. One of the principle advantages of RDC systems is that they allow users to remotely process financial transactions. This can be extremely beneficial to merchants that can complete transactions at the point of service, regardless of the location. It is also helpful to the financial institution in that they can operate without limitation as to physical location and reduce associated overhead. One drawback of such an approach is that an entirely computer processed transaction is subject to fraud, mistake, and manipulation as computer systems are inherently limited with regard to the ability to avoid such problems.

Additionally, the invention applies rules based methodology that provides for security, processing efficiency, and consistency.

Still further, the present invention can utilize multi-factor authentication at the device and rule/review level to ensure user authenticity. This is a system that requires the user to provider more than one form of verification. For example, when the user logs in they can provide a user name and password, and the system could then require additional verification by sending an email or text message to an account of device that would need further action such as entering a password from the email or text message, or requiring the user to select an enabling link. The secondary authentication would ideally require the user to pass through a level of security that is independent from the account that is processing the financial transaction. Other devices that can be used include smart cards, security tokens, biometrics, and the like. This would ensure that even if an unauthorized person gained access to the device or account used to complete the financial transaction they would need to have access to another user secured account or device.

Further yet, all communications to the user described herein, especially those to a user mobile device, can utilize push notification technology and systems. The deposit of the financial instrument can be made directly to the financial institutions CORE (centralized online real-time environment), including if made from a user mobile device.

The present invention solves this problem by providing a human operator the ability to evaluate a transaction prior to approval and therefore apply qualified and skilled expertise to the transaction that is normally reserved for in-person transactions. This advantage is provided without limiting any of the advantages of RDC transactions or processing.

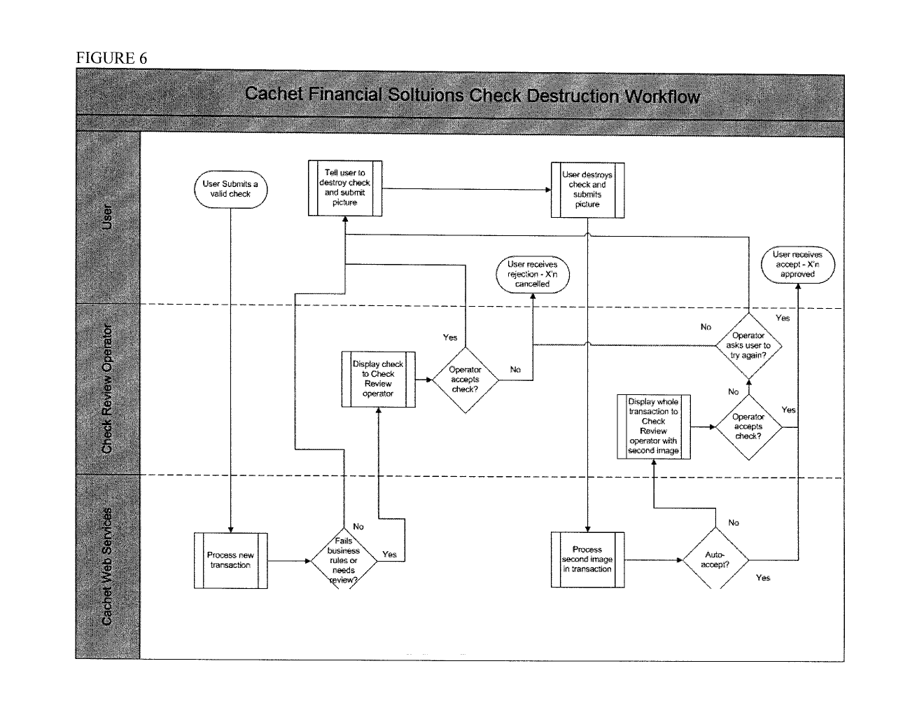

In a still further embodiment of the present invention, a method is shown to manipulate the financial instrument to prevent the instrument from being processed/deposited again. FIG. 6 shows a flow chart according to such method. The process is carried out between a user, an RDC provider, and a financial institution (or some combination thereof), and can utilize the procedures described herein-above.

The process begins with the user submitting a financial instrument, such as a check. The check is processed including verification steps comprising an analysis of one of more business rules, such as those described above. If the check fails the review then it is forwarded for a check reviewer for additional consideration. If the check is not approved by the reviewer, the user receives a rejection notice.

If the check clears the business rule analysis or is cleared by the reviewer the transaction is cleared for processing pending the deposit verification step, and the user is prompted to provide verification that that check has been rendered unsuitable for repeat processing. This verification can take a number of forms. For example, the check can be destroyed by tearing it into pieces. Or, the user can write or stamp something on the front that overwrites major parts of the check, such as “VOID” or “ELECTRONICALLY DEPOSITED” or the like. The notation can be dated or not.

The user would then submit a photograph or scanned image of the check showing the designated deposit verification insignia. The submission would take place in the same manner as the original check was submitted. The second image is then processed to determine if the deposit verification meets an acceptable predefined criteria. If the criteria check fails, the entire transaction is presented to the check reviewer for further action. The reviewer can accept the verification, or can ask the user to resubmit verification (in which case the process just described would repeat). If the automatic verification passes, or the reviewer approves the transaction then the transaction is completed and the user is notified. If the verification fails then the user is also notified of the failure.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A remote deposit capture method, carried out on a computing device under the control of computer executed instructions, comprising:
receiving a scanned image of a financial instrument;
processing the image to extract information relating to a financial transaction;
evaluating the information to determine if it meets an criteria; and
receiving an image of an altered financial instrument, provided the criteria are met,
wherein the alteration indicates that the financial instrument has been processed.

2. The method of claim 1 wherein the alteration comprises writing.

3. The method of claim 1 wherein the alteration comprises a stamp.

4. The method of claim 1 wherein the alteration comprises the phrase “electronically deposited.”

5. The method of claim 1 wherein the alteration comprises the phrase “void.”

6. The method of claim 1 wherein the alteration comprises physically destroying the financial instrument.

7. The method of claim 1 wherein the alteration is dated.

8. The method of claim 1 further comprising the step of evaluating the altered image to determine if the alteration meets a criterion.

9. The method of claim 8 wherein if the alteration does not meet the criteria an opportunity to submit a new altered image is provided.

10. The method of claim 1 further comprising the step of sending notification of the evaluation.

11. The method of claim 10 wherein the notification is sent to a user.

12. The method of claim 10 wherein the notification is of a failure.

13. The method of claim 10 wherein the notification is a success.

14. The method of claim 1 wherein the criteria is performed by a human.

15. The method of claim 8 wherein the alteration criteria is performed by a human.

16. The method of claim 1 wherein the financial instrument is a check.

17. The method of claim 16 further comprising the step of crediting the check to an account.

18. The method of claim 16 further comprising the step of making available funds identified on the check.

19. The method of claim 1 wherein the alteration is on the front side of the financial instrument.

20. The method of claim 1 wherein the alteration is on the back side of the financial instrument.
